(19) United States
(12) Patent Application Publication
(10) Pub. No.: US 2016/0114500 A1
(43) Pub. Date: Apr. 28, 2016

(54) Method and apparatus for producing a carbon-fiber-reinforced polymers additiuonally reinforced by alumina nanofibers

(71) Applicant: Ilya Grodnensky, Foster City, CA (US)

(72) Inventor: Ilya Grodnensky, Foster City, CA (US)

(21) Appl. No.: 14/121,855

(22) Filed: Oct. 23, 2014

(51) Int. Cl. B29B 11/16

(52) U.S. Cl. CPC B29B 11/16; B29K 2063/00

(57) ABSTRACT

Carbon-fiber-reinforced polymers are composite materials. In this case the composite consists of two parts; a matrix and a reinforcement. In CFRP the reinforcement is carbon fiber, which provides the strength. The matrix is usually a polymer resin, such as epoxy, to bind the reinforcements together. Because CFRP consists of two distinct elements, the material properties depend on these two elements. In accordance with one aspect of the invention, there is provided a method and apparatus for producing carbon-fiber-reinforced polymers, wherein the polymer resin used in their manufacture is additionally reinforced by unidirectionally oriented pre-dispersed alumina nanofibers. The aforesaid process is well suited for industrial-scale production of the carbon-fiber-reinforced polymers. In one or more embodiments, the production process involves dispersing alumina nanofibers in the polymer resin, such as epoxy, and using the resulting alumina nanofiber-reinforced polymer resin in the production of the carbon-fiber-reinforced polymers.

### CROSS-REFERENCE TO RELATED PATENT APPLICATIONS

This non-provisional patent application is based on and claims the benefit of priority from U.S. provisional patent application No. 61/894,418 filed on Oct. 23, 2013, the entire disclosure of which is incorporated by reference herein.

### BACKGROUND OF THE INVENTION

1. Field of the Invention

This described embodiments relate in general to material science and, more specifically, to a method and apparatus for producing a carbon-fiber-reinforced polymers additionally reinforced by alumina nanofibers.

2. Description of the Related Art

Carbon-fiber-reinforced polymer, carbon-fiber-reinforced plastic or carbon-fiber reinforced thermoplastic (CFRP, CRP, CFRTP or often simply carbon fiber, or even carbon), is an extremely strong and light fiber-reinforced polymer which contains carbon fibers. The binding polymer is often a thermoset resin such as epoxy, but other thermoset or thermoplastic polymers, such as polyester, vinyl ester or nylon, are sometimes used. The composite may contain other fibers, such as aramid e.g. Kevlar, Twaron, aluminium, or glass fibers, as well as carbon fiber. The properties of the final CFRP product can also be affected by the type of additives introduced to the binding matrix (the resin). The most frequent additive is silica, but other additives such as rubber and carbon nanotubes can be used. CFRPs are commonly used in the transportation industry; normally in cars, boats and trains, and in sporting goods industry for manufacture of bicycles, bicycle components, golfing equipment and fishing rods.

Although carbon fiber can be relatively expensive, it has many applications in aerospace and automotive fields, such as Formula One racing. The compound is also used in sailboats, rowing shells, modern bicycles, and motorcycles because of its high strength-to-weight ratio and very good rigidity. Improved manufacturing techniques are reducing the costs and time to manufacture, making it increasingly common in small consumer goods as well, such as certain ThinkPads since the 600 series, tripods, fishing rods, hockey sticks, paintball equipment, archery equipment, tent poles, racquet frames, stringed instrument bodies, drum shells, golf clubs, helmets used as a paragliding accessory and pool/billiards/snooker cues.

To achieve carbon fiber composite material with even better mechanical characteristics, new and improved techniques for reinforcing the binding polymer used in its production are needed.

### SUMMARY OF THE INVENTION

The inventive methodology is directed to methods and systems that substantially obviate one or more of the above and other problems associated with conventional techniques for manufacturing the carbon-fiber-reinforced polymers.

In accordance with one aspect of the embodiments described herein there is provided a method for producing a nanocomposite polymeric material reinforced by co-oriented pre-dispersed alumina Al₂O₃ nanofibers, the method involving: saturating a structure of co-oriented pre-dispersed alumina Al₂O₃ nanofibers with a polymer matrix; and facilitating polymerization of the polymer matrix to produce the nanocomposite polymeric material.

In one or more embodiments, the polymer matrix is pre-heated to a melting point.

In one or more embodiments, facilitating polymerization comprises cooling of the polymer matrix.

In one or more embodiments, facilitating polymerization comprises exposing the polymer matrix to ultraviolet light and/or electron beam.

In one or more embodiments, facilitating polymerization comprises adding a chemical hardener to the polymer matrix.

In one or more embodiments, the method further comprises subjecting the nanocomposite polymeric material to an ultrasound to facilitate dispersion of the alumina Al₂O₃ nanofibers.

In one or more embodiments, the method further comprises subjecting the nanocomposite polymeric material to a hydrodynamic stress to facilitate dispersion of the alumina Al₂O₃ nanofibers.

In one or more embodiments, the polymerization of the polymer matrix is performed in an atmosphere of air.

In one or more embodiments, the structure of co-oriented alumina Al₂O₃ nanofibers comprises a plurality of co-oriented, pre-dispersed alumina Al₂O₃ nanofibers.

In one or more embodiments, the polymer matrix comprises thermosets or thermoplastics.

In accordance with another aspect of the embodiments described herein there is provided a nanocomposite polymeric material reinforced by co-oriented pre-dispersed alumina Al₂O₃ nanofibers prepared by a process involving: saturating a structure of co-oriented pre-dispersed alumina Al₂O₃ nanofibers with a polymer matrix; and facilitating polymerization of the polymer matrix to produce the nanocomposite polymeric material.

In one or more embodiments, the polymer matrix is pre-heated to a melting point.

In one or more embodiments, facilitating polymerization comprises cooling of the polymer matrix.

In one or more embodiments, facilitating polymerization comprises exposing the polymer matrix to ultraviolet light and/or electron beam.

In one or more embodiments, facilitating polymerization comprises adding a chemical hardener to the polymer matrix.

In one or more embodiments, the method further comprises subjecting the nanocomposite polymeric material to an ultrasound to facilitate dispersion of the alumina Al₂O₃ nanofibers.

In one or more embodiments, the method further comprises subjecting the nanocomposite polymeric material to a hydrodynamic stress or vacuum to facilitate dispersion of the alumina Al₂O₃ nanofibers.

In one or more embodiments, the polymerization of the polymer matrix is performed in an atmosphere of air.

In one or more embodiments, the structure of co-oriented alumina Al₂O₃ nanofibers comprises a plurality of co-oriented, pre-dispersed alumina Al₂O₃ nanofibers.

In one or more embodiments, the polymer matrix comprises thermosets or thermoplastics.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a reactor for synthesis of aluminum oxide nanofibers.

FIG. 2 illustrates an exemplary embodiment of a method for production of aluminum oxide nanofibers.

FIGS. 3 and 4 illustrate a mat-like structure of the produced co-oriented pre-dispersed alumina nanofibers.

FIG. 5 illustrates an exemplary embodiment of a secondary reactors for producing alumina nanofibers having an increased surface area.

FIG. 6 illustrates a scanning electron microscope (SEM) image of the polymer matrix without reinforcing alumina nanofibers.

FIG. 7 shows a top-view SEM image of a composite material reinforced by the alumina nanofibers manufactured in accordance with techniques described above.

FIG. 8 shows a side-view SEM image of a composite material reinforced by alumina nanofibers.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

Carbon-fiber-reinforced polymers are composite materials. In this case the composite consists of two parts; a matrix and a reinforcement. In CFRP the reinforcement is carbon fiber, which provides the strength. The matrix is usually a polymer resin, such as epoxy, to bind the reinforcements together. Because CFRP consists of two distinct elements, the material properties depend on these two elements. In accordance with one aspect of the invention, there is provided a method and apparatus for producing a carbon-fiber-reinforced polymers, wherein the polymer resin used in its manufacture is additionally reinforced by unidirectionally oriented pre-dispersed alumina nanofibers. The aforesaid process is well suited for industrial-scale production of the carbon-fiber-reinforced polymers. In one or more embodiments, the production process involves dispersing alumina nanofibers in the polymer resin, such as epoxy, and using the resulting alumina nanofiber-reinforced polymer resin in the production of the carbon-fiber-reinforced polymers. In one or more embodiments, the carbon-fiber-reinforced polymers may be produced from carbon fiber and the alumina nanofiber-reinforced polymer resin according to conventional techniques well known in the art. In one or more embodiments, the resulting material is composed of the polymer resin reinforced by both the carbon fiber and the dispersed uniformly oriented reinforcing alumina nanofibers.

In one or more embodiments, before the production of the carbon-fiber-reinforced polymer, the alumina nanofibers in the polymer resin are pre-dispersed by means of subjecting to hydrodynamic stress, as described, for example in European Patent Publication No. EP1818358 A1, incorporated herein by reference. Additionally or alternatively, the alumina nanofibers in the polymer resin may be subject to mechanical or/and ultrasound coarse dispersing.

In accordance with one or more embodiments of the invention, at the first step of the inventive process, polycrystalline alumina nanofibers are produced by controlled liquid phase oxidation of aluminum. In one or more embodiments, the alumina nanofibers synthesis method comprises two stages. During the first stage, various additives are introduced into molten metallic aluminum. During the second stage, the alumina nanofibers are synthesized from the resulting melt in the presence of oxygen. In one or more embodiments, the inventive method is performed in a reactor.

Subsequently, at the second process step, the manufactured alumina nanofibers are combinated with a polymer matrix. Upon drying, the resulting nanocomposite material reinforced by alumina nanofibers is produced. In one or more embodiments, the alumina nanofibers act to enhance mechanical, thermal, optical and electrical properties of the polymer base.

The aforesaid two steps of the inventive nanocomposite material synthesis process will now be described in detail. It should be noted that the below description primarily deals with alumina nanofibers possessing two linear dimensions of less than 45 nm. Because the nanofibers described herein have circular cross section, the size of the nanofiber will be specified below by reference to its diameter.

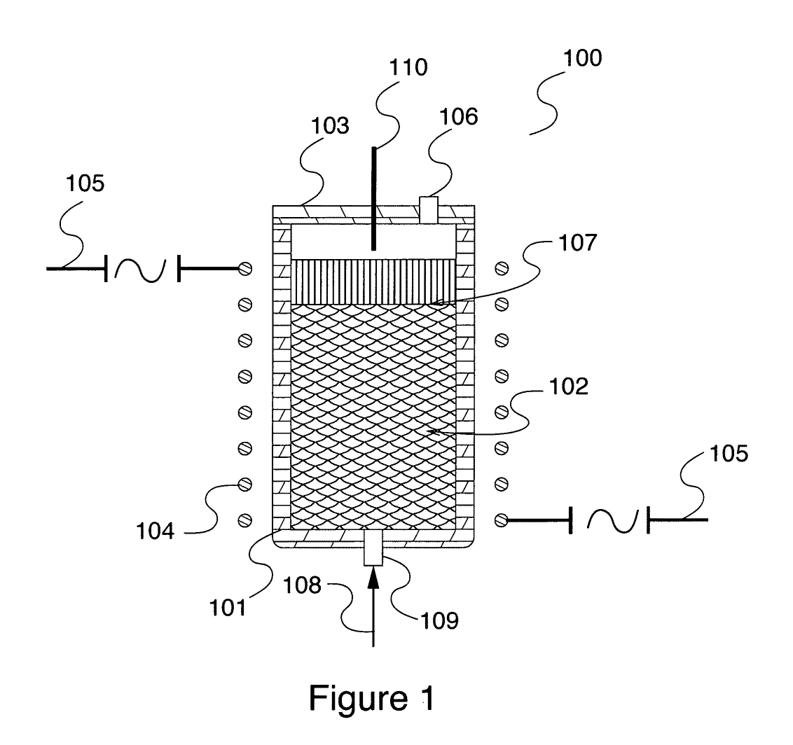

In accordance with one or more embodiments of the invention, the alumina nanaofibers are produced in a reactor. The aforesaid reactor is designed to provide the heating and enable melting of the aluminum. An exemplary embodiment of the reactor 100 is illustrated in FIG. 1. The shown embodiment of the reactor 100 incorporates reactor body 101 enclosing a reaction chamber, which contains the melt 102. The reactor 100 is closed from the top using cover 103, which may incorporate one or more sensor assembly 110 for monitoring various parameters inside the reactor 100, including, without limitation, temperature, pressure, humidity and oxygen content. The reactor cover 103 may also incorporate one or more valve assemblies 106 for controlling the atmosphere inside the reactor. In addition, an inlet 109 may be provided in the bottom part of the reactor 100 for injecting various additives and oxygen into the reactor 100, see numeral 108. In one or more embodiments, the content of the reactor may be heated using a suitable induction heating mechanism, which may incorporate induction coil 104 electrically connected to an electric current source 105. The zone of synthesis of aluminum oxide nanofibers is marked in Figure with numeral 107. The oxygen content inside the reactor 100 may be automatically monitored and/or altered using control logic.

In one or more embodiments, the reactor is designed to maintain a sustained temperature of between 660° C. and 1,000° C. When the additives described below are introduced into the molten aluminum, it is desirable to provide steady and uniform the stirring of the melt. To this end, the aforesaid reactor may be provided with a stirring mechanism (not shown in FIG. 1). The construction of the reactor should also provide control over gas composition of the atmosphere during both the introduction of the additives and during the synthesis of the nanofibers. In one or more embodiments, the oxygen content of the atmosphere should be 0.00001 wt. % (weight percent) to 99.9 wt. % depending on the stage of the synthesis process.

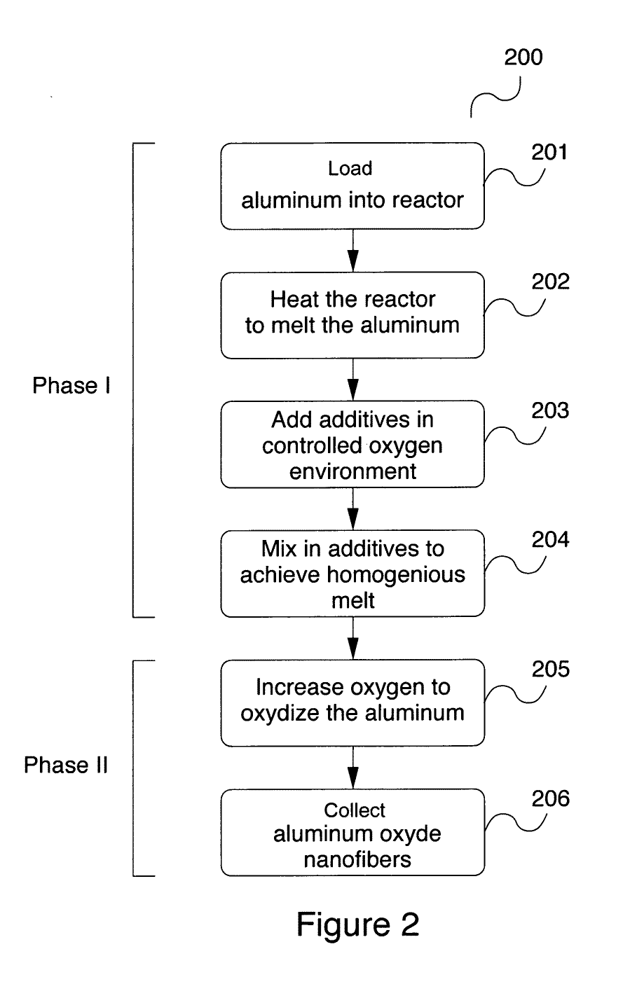

FIG. 2 illustrates an exemplary embodiment of the inventive method 200 for production of aluminum oxide nanofibers. In accordance with one or more embodiments of the invention, during the first, additive introduction phase (Phase I in FIG. 2) of the inventive process 200, the oxygen content of the atmosphere is kept to the minimal oxygen concentration. On the other hand, during the second, synthesis stage (Phase II in FIG. 2), the oxygen content should be higher, depending on the temperature and the required speed of the nanofiber synthesis process.

In accordance with one or more embodiments of the invention, the heating of the melt is performed using induction heating or electrical resistance heating (ERH, also known as electrical resistive heating) methods, which are well known to persons of ordinary skill in the art. To this end, the reactor may incorporate an appropriate heater. However, the present invention is not limited only to the aforesaid induction heating or electrical resistance heating methods and any other suitable heating method could be utilized for heating, melting and maintaining the required temperature of the material. It should be noted that the heater should preferably provide even heating of the entire volume of the material in the reactor. In addition, in one or more embodiment, the reactor incorporates means for controlling the content of the atmosphere inside the reactor. Construction and methods of application of such means are well known to persons of ordinary skill in the art.

In accordance with one or more embodiments of the invention, in order to synthesize alumina nanofibers, metallic aluminum having purity of 99.7% is first loaded into the reactor 100 in step 201 and melted in the reactor n step 202, see FIG. 2. It should be noted that it is also possible to use other grades of aluminum, as long as the chemical composition of the material described below is achieved. In accordance with one or more embodiments of the invention, the melt is subsequently heated to 900° C., and additives are introduced into the melt to achieve certain predetermined concentrations.

In accordance with one or more embodiments of the invention, the following additives are introduced into the heated melt in step 203 to achieve an additive concentration in the range indicated next to the respective additive:

a. Iron (Fe) at concentration between 0.1 and 12 wt. %;

b. Selenium (Se) at concentration between 0.1 and 12 wt. %;

c. Tellurium (Te) at concentration between 0.1 and 12 wt. %; and

d. Zirconium (Zr) at concentration between 0.1 and 12 wt. %.

In one or more embodiments, a. through d. above summed up represent less than 49 wt. % of the molten metallic aluminum, and all other elements (except for aluminum) together comprise less than 1 wt. % of the molten metallic aluminum.

In accordance with one or more embodiments of the invention, the aforesaid additives are introduced into the melt not in their pure form, but as part of compositions and/or alloys. This may facilitate the dissolution of the respective additives in the melt and result in a higher degree of homogeneity of the melt.

In one embodiment of the inventive technique, one or more of the aforesaid additives are introduced into the melt in a solid powder form. In an alternative embodiment, the additives may be introduced in a pre-melted form. To facilitate attaining the proper homogeneity of the resulting melt, in one or more embodiments, the stirring mechanism may be used in the reactor 100 to perform mixing in of the additives in step 204, see FIG. 2.

In accordance with one or more embodiments of the invention, once suitably homogeneous melt is obtained, oxygen is introduced into the melt or oxygen content is increased, see step 205. In one or more embodiments, oxygen is introduced through melt's surface by means of diffusion. In another embodiment, oxygen is injected into the melt using an injector. Finally, in an alternative embodiment, oxygen is introduced into the melt through introducing a composition or compositions of oxygen with one or more of the following chemical elements: Iron (Fe), Selenium (Se), Tellurium (Te) and Zirconium (Zr).

In accordance with one or more embodiments of the invention, oxygen is introduced up to a concentration of 5 wt. %. Once oxygen is introduced and reaches the indicated concentration, the synthesis of nanofibers takes place either on the surface of the melt or on a boundary between the molten aluminum and another medium. In one or more embodiments, the grown polycrystalline alumina Al₂O₃ nanofibers are harvested from the surface of the molten metallic aluminum or from the boundary of the molten metallic aluminum and another medium. In accordance with one or more embodiments of the invention, the synthesis of the polycrystalline alumina Al₂O₃ nanofibers is performed within temperature range of the molten metallic aluminum from 660° C. to 1000° C. Finally, the aluminum nanofibers are collected at step 206. In one or more embodiments, the aluminum nanofibers are synthesized in gamma phase. In various alternative embodiments, the alumina nanofibers may be synthesized in KsI (Xi) phase, Ksi (Xi) and Gamma mixed phase or other phases, depending on the specific parameters of the synthesis process.

In accordance with one or more embodiments of the invention, it order to insure continuous nanofiber synthesis process, it is desirable to provide a steady supply of oxygen to the reactor to maintain oxygen concentration within desired limits. In addition, the chemical composition of the melt and the temperature should also be appropriately maintained within proper limits during the synthesis process.

As the alumina nanofibers are formed on the surface of the melt during the synthesis process, they can be harvested from the melt's surface. The diameter of the produced nanofibers can be controlled through the parameters of the synthesis process, such as temperature and chemical composition of the melt. On the other hand, the length of the produced nanofibers is determined by synthesis time. In one or more embodiments, the nanofiber synthesis speed may vary from 0.1 cm/hour to 1 cm/hour. It should be noted that the described method may also be utilized to synthesize polycrystalline alumina nanofibers by changing the synthesis conditions during the synthesis process and/or by applying an external action on the surface of the molten aluminum.

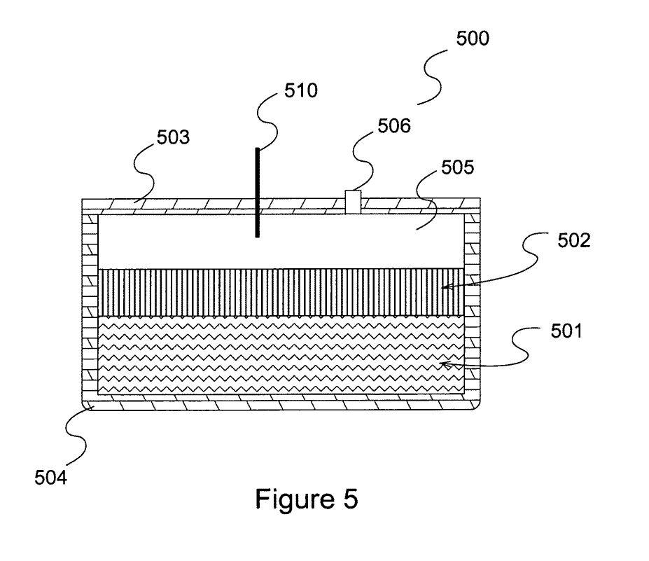

In one or more embodiments, to increase the production yield of aluminum nanofibers, after heating and adding the aforesaid additives, the aluminum melt may be transferred from the reactor 100 shown in FIG. 1 to one or more secondary reactors 500 having an increased surface area, as shown in FIG. 5. The aforesaid transfer of the melt may be performed in an atmosphere of noble gases. In an alternative embodiment, the melt transfer many be performed in oxygen-containing atmosphere. However, in this case, it is desirable to perform the transfer very quickly to prevent oxidation of the melt during the transfer. The aluminum oxide nanofibers 502 are produced in one or more secondary reactors 500 in oxygen-containing atmosphere 505 at an increased amount due to increased surface area of the melt 501. Similar to the reactor 100, in one or more embodiments, the secondary reactor 500 may include a reactor body 504, top cover 503, one or more sensor assemblies 510 and one or more valve assemblies 506, which may perform substantially the same functions as the corresponding elements of the reactor 100.

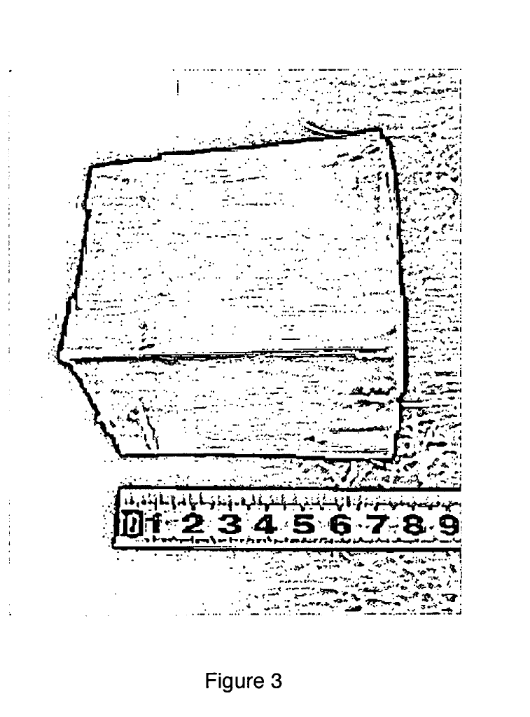

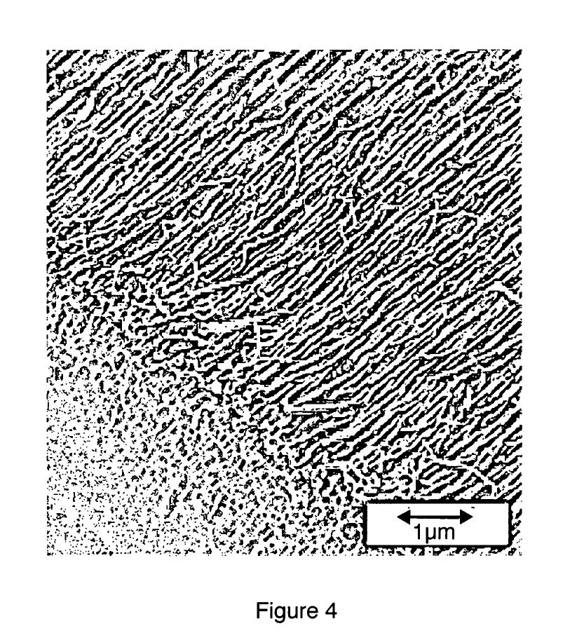

The alumina nanofibers produced according to techniques described above form a mat-like structure shown, for example, in FIGS. 3 and 4. In the aforesaid nanofiber structure, the alumina nanofibers are all oriented in the same transverse direction. Also, in the described structure, the nanfibers are pre-dispersed. In accordance with one or more embodiments, the pre-dispersed co-oriented alumina nanofibers are combined with polymer resin, such as epoxy. In one or more embodiments, the alumina nanofibers in the polymer resin can be additionally dispersed using any dispersion technique known in the art. For example, additional dispersion may be achieved by means of subjecting the nanofibers in the polymer resin to hydrodynamic stress, as described, for example in European Patent Publication No. EP1818358 A1, incorporated herein by reference. Additionally or alternatively, the alumina nanofibers in the polymer resin may be subject to mechanical or/and ultrasound coarse dispersing.

In various embodiments, the composition of the nanofibers in the polymer resin may range from above zero to 10 wt. %. In one or more embodiments, the composition ranged between 1 wt. % and 4 wt. %. In one or more embodiments, the polymer resin comprises block copolymers, thermoplastics, liquid crystal polymers, thermosets, gel processed polymers and elastomers. In one or more embodiments, the polymer matrix is a transparent polymer matrix. In one or more embodiments, the alumina nanofibers are combined with the polymer matrix in a presence of water and/or other solvent(s). In one or more embodiments, the polymer matrix is selected from a group comprising: poly(meth)acrylate, polystyrene, polyester, polycarbonate, polyolefin, polyamide, polyurethane, polyacetal, polyvinyl acetal, polyvinyl ketal, vinyl polymer or copolymer comprising vinyl monomer selected from (meth)acrylate ester, aromatic vinyl, vinyl cyanide, vinyl halide and vinylidene halide; preferably it is selected from the group of polyalkylene terephthalate, polycarbonate of bisphenol compound, vinyl polymer or copolymer comprising vinyl monomer selected from methyl methacrylate, styrene and acrylonitrile and any combinations thereof. In one or more embodiment, the polymer resin may comprise an epoxy-based polymer.

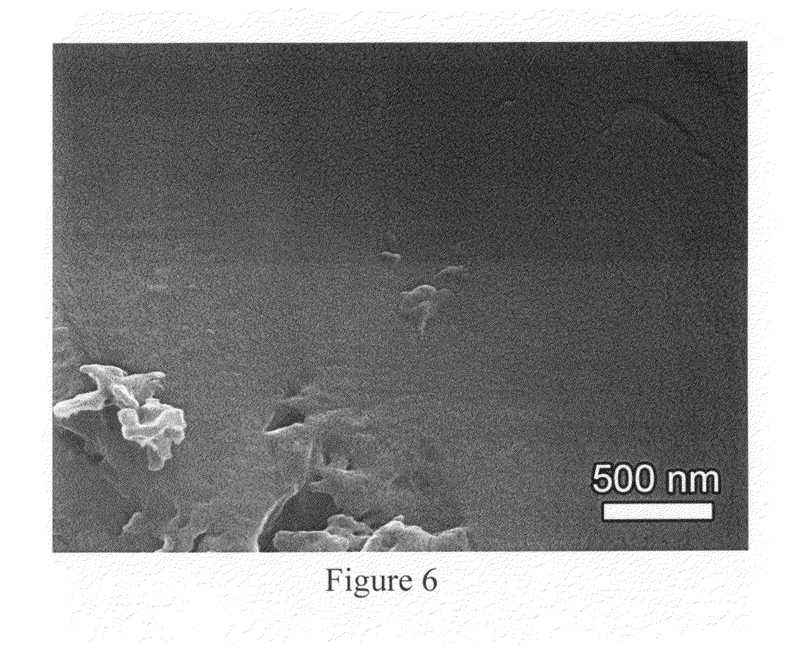

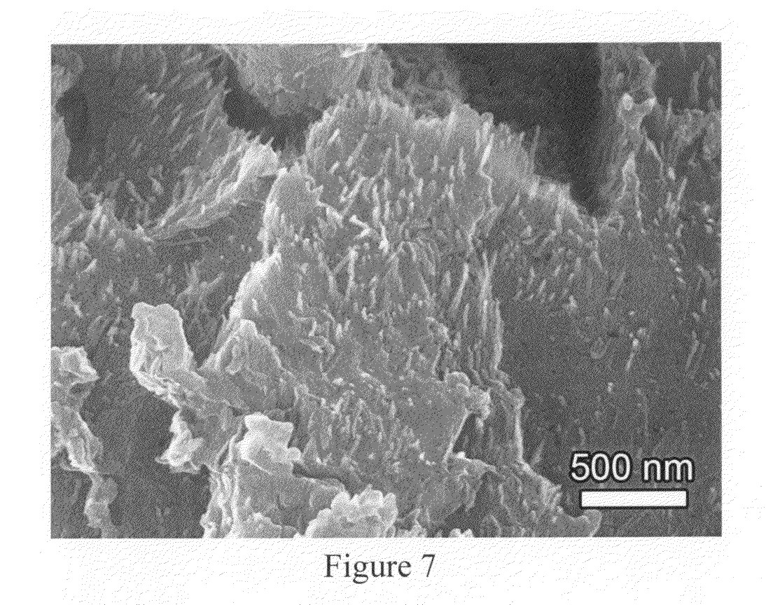

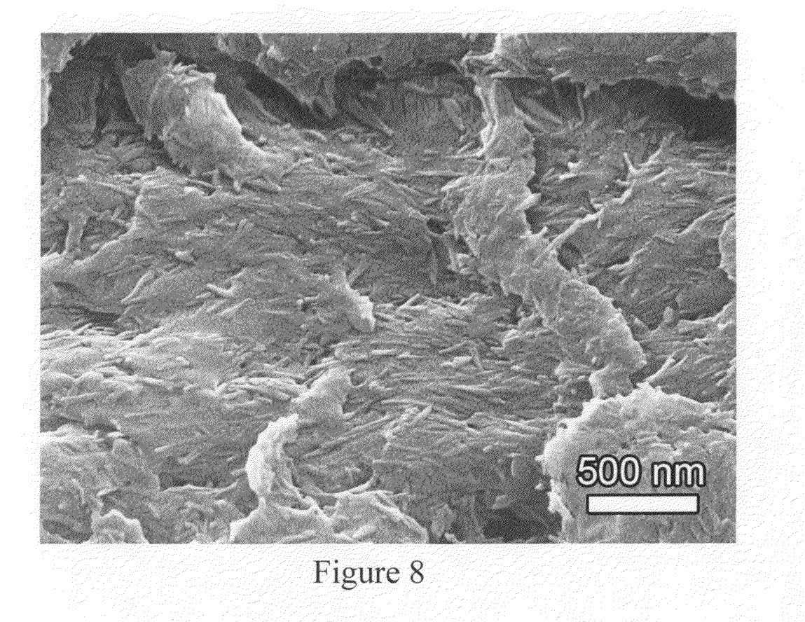

FIG. 6 illustrates a scanning electron microscope (SEM) image of the polymer resin without reinforcing alumina nanofibers. FIG. 7 shows a top-view SEM image of a polymer resin reinforced by the alumina nanofibers manufactured in accordance with techniques described above. FIG. 8 shows a side-view SEM image of a polymer resin reinforced by alumina nanofibers. In can be seen from FIGS. 7 and 8 that the alumina nanofibers in the reinforced resin are predominantly well dispersed and spatially co-oriented without significant agglomeration effects present.

After the nanofiber-reinforced polymer resin is produced using the techniques described above, carbon-fiber-reinforced polymers are manufactured using any manufacturing process know in the art. Several exemplary embodiments of carbon-fiber-reinforced polymer manufacturing processes are described below.

First, unidirectional carbon fiber sheets are created. These sheets are layered onto each other in a quasi-isotropic layup, e.g. 0°, +60° or −60° relative to each other. From the elementary fiber, a bidirectional woven sheet can be created, i.e. a twill with a 2/2 weave. The process by which most carbon-fiber-reinforced polymer is made varies, depending on the piece being created, the finish (outside gloss) required, and how many of this particular piece are going to be produced. In addition, the choice of matrix can have a profound effect on the properties of the finished composite. Many carbon-fiber-reinforced polymer parts are created with a single layer of carbon fabric that is backed with fiberglass. A tool called a chopper gun is used to quickly create these composite parts. Once a thin shell is created out of carbon fiber, the chopper gun cuts rolls of fiberglass into short lengths and sprays resin at the same time, so that the fiberglass and resin are mixed on the spot. The resin is either external mix, wherein the hardener and resin are sprayed separately, or internal mixed, which requires cleaning after every use. Manufacturing methods may include the following:

Molding

One method of producing graphite-epoxy parts is by layering sheets of carbon fiber cloth into a mold in the shape of the final product. The alignment and weave of the cloth fibers is chosen to optimize the strength and stiffness properties of the resulting material. The mold is then filled with the nanofiber-reinforced polymer resin (epoxy) and is heated or air-cured. The resulting part is very corrosion-resistant, stiff, and strong for its weight. Parts used in less critical areas are manufactured by draping cloth over a mold, with the nanofiber-reinforced polymer epoxy either preimpregnated into the fibers (also known as pre-preg) or “painted” over it. High-performance parts using single molds are often vacuum-bagged and/or autoclave-cured, because even small air bubbles in the material will reduce strength. An alternative to the autoclave method is to use internal pressure via inflatable air bladders or EPS foam inside the non-cured laid-up carbon fiber.

Vacuum Bagging

For simple pieces of which relatively few copies are needed, (1-2 per day) a vacuum bag can be used. A fiberglass, carbon fiber or aluminum mold is polished and waxed, and has a release agent applied before the fabric and the nanofiber-reinforced polymer resin are applied, and the vacuum is pulled and set aside to allow the piece to cure (harden). There are two ways to apply the nanofiber-reinforced polymer resin to the fabric in a vacuum mold. One is done manually and called a wet layup, where the nanofiber-reinforced polymer resin is mixed and applied before being laid in the mold and placed in the bag. The other one is done by infusion, where the dry fabric and mold are placed inside the bag while the vacuum pulls the nanofiber-reinforced polymer resin through a small tube into the bag, then through a tube with holes or something similar to evenly spread the resin throughout the fabric. Wire loom works perfectly for a tube that requires holes inside the bag. Both of these methods of applying the nanofiber-reinforced polymer resin require hand work to spread the resin evenly for a glossy finish with very small pin-holes. A third method of constructing composite materials is known as a dry layup. Here, the carbon fiber material is already impregnated with the nanofiber-reinforced polymer resin (prepreg) and is applied to the mold in a similar fashion to adhesive film. The assembly is then placed in a vacuum to cure. The dry layup method has the least amount of resin waste and can achieve lighter constructions than wet layup. Also, because larger amounts of resin are more difficult to bleed out with wet layup methods, prepreg parts generally have fewer pinholes. Pinhole elimination with minimal resin amounts generally require the use of autoclave pressures to purge the residual gases out.

Compression Molding

A quicker method uses a compression mold. This is a two-piece (male and female) mold usually made out of fiberglass or aluminum that is bolted together with the fabric and alumina nanofiber-reinforced polymer resin between the two. The benefit is that, once it is bolted together, it is relatively clean and can be moved around or stored without a vacuum until after curing. However, the molds require a lot of material to hold together through many uses under that pressure.

Filament Winding

For difficult or convoluted shapes, a filament winder can be used to make CFRP parts by winding filaments around a mandrel or a core.

It should be noted that, other implementations of the invention will be apparent to those skilled in the art from consideration of the specification and practice of the invention disclosed herein. Various aspects and/or components of the described embodiments may be used singly or in any combination in the process for manufacturing carbon-fiber-reinforced polymers. It is intended that the specification and examples be considered as exemplary only, with a true scope and spirit of the invention being indicated by the following claims.

What is claimed is:

1. A method for producing a carbon-fiber-reinforced polymer additionally reinforced by alumina Al₂O₃ nanofibers, the method comprising:
a. producing alumina Al₂O₃ nanofibers using controlled liquid-phase oxidation of molten aluminum;
b. combining the produced alumina Al₂O₃ nanofibers with a polymer resin;
c. dispersing the alumina Al₂O₃ nanofibers in the polymer resin;
d. producing the carbon-fiber-reinforced polymer by combining carbon fibers with the polymer resin with the dispersed alumina Al₂O₃ nanofibers.

2. The method of claim 1, wherein the polymer resin is epoxy.
